(19) United States
(12) Patent Application Publication
(10) Pub. No.: US 2026/0302568 A1
(43) Pub. Date: Oct. 1, 2026

(54) BATTERY PACK

(71) Applicant: TOYOTA JIDOSHA KABUSHIKI KAISHA, Toyota-shi (JP)

(72) Inventor: Naoya KAWAMOTO, Nisshin-shi (JP)

(73) Assignee: TOYOTA JIDOSHA KABUSHIKI KAISHA, Toyota-shi (JP)

(21) Appl. No.: 19/438,920

(22) Filed: Jan. 2, 2026

(30) Foreign Application Priority Data
Mar. 26, 2025 (JP) 2025-052557

(51) Int. Cl. H01M 50/591; H01M 10/46; H01M 50/249; H01M 50/298; H01M 50/503; H01M 50/507; H01M 50/593

(52) U.S. Cl. CPC H01M 50/591; H01M 10/46; H01M 50/249; H01M 50/298; H01M 50/503; H01M 50/507; H01M 50/593

(57) ABSTRACT

A charging bus bar that a battery pack is equipped with includes a charging positive bus bar main body and a charging negative bus bar main body. The charging positive bus bar main body has a positive-side parallel extending portion that is strip-shaped, and the charging negative bus bar main body has a negative-side parallel extending portion that is strip-shaped. The positive-side parallel extending portion and the negative-side parallel extending portion have plate thickness directions thereof oriented in the same direction, and also extend parallel to each other with a gap between in the plate thickness direction.

### CROSS-REFERENCE TO RELATED APPLICATION

This application claims priority to Japanese Patent Application No. 2025-052557 filed on Mar. 26, 2025. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

Japanese Unexamined Patent Application Publication No. 2020-057530 (JP 2020-057530 A) discloses a battery pack that can be installed in a vehicle. This battery pack includes a battery (battery assembly), internal battery equipment (junction box) that is electrically connected to the battery, and an accommodating case (casing).

### SUMMARY

Now, a charging bus bar may be provided as a component of such a battery pack described above, making up a portion of wiring connecting a charging port and the internal battery equipment.

An object of the present disclosure is to reduce noise caused by the charging bus bar.

A battery pack according to a first aspect is a battery pack that is installed in a vehicle, the battery pack including a battery, internal battery equipment that is electrically connected to the battery, a charging bus bar that makes up a portion of wires connecting a charging port provided outside of the battery pack and the internal battery equipment, and an accommodating case that accommodates the battery, the internal battery equipment, and the charging bus bar, in which the charging bus bar includes a charging positive bus bar main body and a charging negative bus bar main body, the charging positive bus bar main body includes a positive-side parallel extending portion that is strip-shaped, the charging negative bus bar main body includes a negative-side parallel extending portion that is strip-shaped, and a plate thickness direction of the positive-side parallel extending portion and a plate thickness direction of the negative-side parallel extending portion are oriented in the same direction, and also extend parallel to each other with a gap between in the plate thickness direction.

The present aspect relates to a battery pack that can be installed in a vehicle. The battery pack includes the battery, the internal battery equipment electrically connected to the battery, the charging bus bar that forms a portion of the wiring connecting the charging port provided externally from the battery pack to the internal battery equipment, and the accommodating case that accommodates the battery, the internal battery equipment, and the charging bus bar. The charging bus bar includes the charging positive bus bar main body and the charging negative bus bar main body.

Now, noise may be generated due to the charging bus bar such as described above. Accordingly, in this aspect, the charging positive bus bar main body has the positive-side parallel extending portion that is strip-shaped, and the charging negative bus bar main body has the negative-side parallel extending portion that is strip-shaped. The positive-side parallel extending portion and the negative-side parallel extending portion have plate thickness directions thereof oriented in the same direction, and also extend parallel to each other with a gap between in the plate thickness direction. Accordingly, magnetic fields generated around the charging bus bar can be canceled out, and as a result, noise caused by the magnetic fields can be reduced.

According to the present disclosure, noise caused by charging bus bars can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a vehicle equipped with a battery pack;

FIG. 2 is a schematic cross-sectional view illustrating a vicinity of a rear end portion of the battery pack in an enlarged manner;

FIG. 3 is a plan view illustrating a state in which internal battery equipment is accommodated in an equipment case lower member;

FIG. 4 is a plan view illustrating a state in which the internal battery equipment is accommodated in the equipment case lower member and also a charging bus bar is connected thereto;

FIG. 5A is a plan view of the charging bus bar;

FIG. 5B is a rear view of the charging bus bar; and

FIG. 6 is a cross-sectional view taken along line 5-5 in FIG. 5A.

### DETAILED DESCRIPTION OF EMBODIMENTS

A preferred embodiment of the present disclosure will be described below. Note that with respect to arrows that are shown in the drawings as appropriate, arrow FR indicates vehicle forward, arrow UP indicates vehicle upward, and arrow LH indicates left side in a vehicle width direction, respectively.

A battery pack 13 according to the present embodiment is disposed downward from a vehicle cabin of a vehicle 10.

The battery pack 13 includes a battery 20, internal battery equipment 30 that is electrically connected to the battery 20, and accommodating cases 40, 50 for accommodating these components.

The accommodating cases 40, 50 include a battery case 40 that accommodates the battery 20 and an equipment case 50 that accommodates the internal battery equipment 30.

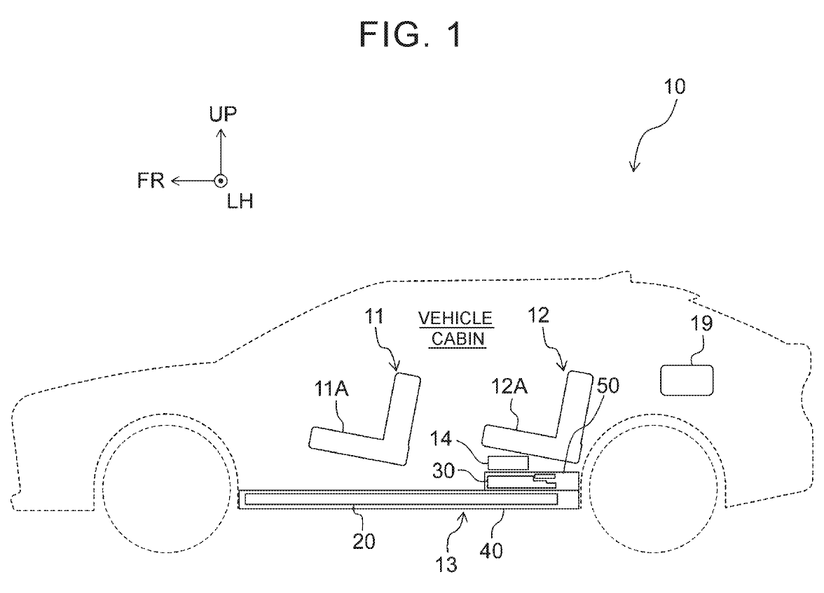

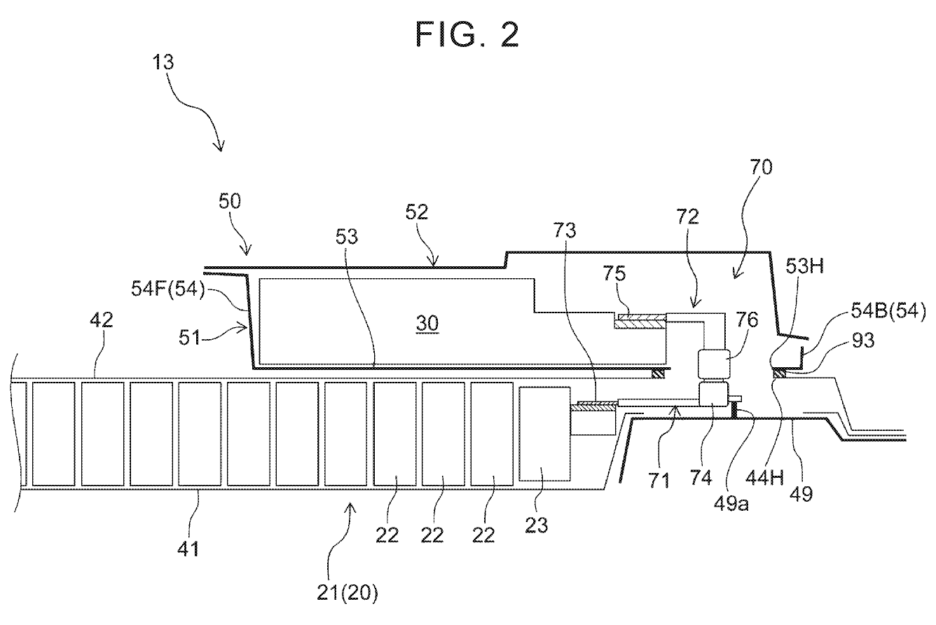

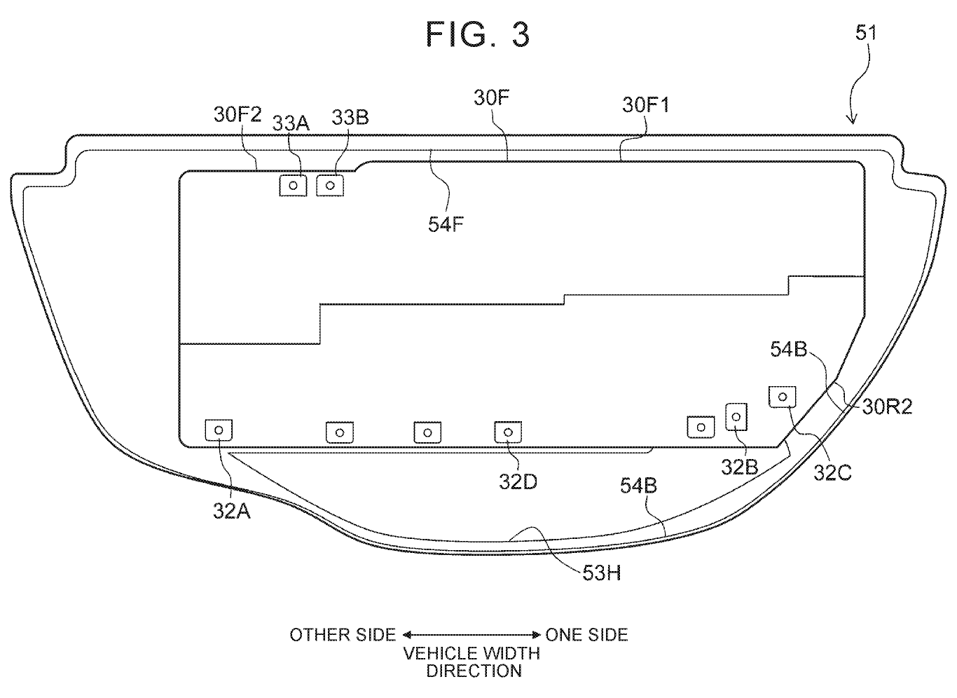

As illustrated in FIG. 1, the equipment case 50 is disposed upward from the battery case 40 so as to overlap a portion of the battery case 40 in top view, in its entirety.

As illustrated in FIG. 1, a portion of the battery 20 overlaps at least a portion of a seat face 11A of a front seat 11 in top view, and also another portion of the battery 20 overlaps at least a portion of a seat face 12A of a rear seat 12 in top view. The battery 20 includes a plurality of battery modules 21. The battery 20 includes four battery modules 21. The battery modules 21 are disposed arrayed side by side in the vehicle width direction. Each of the battery modules 21 includes a plurality of battery cells 22 disposed arrayed side by side in the vehicle front-rear direction.

The internal battery equipment 30 is a junction block 30. The internal battery equipment 30 includes electronic components (omitted from illustration) such as bus bars, relays, fuses, and so forth. The relay includes a system main relay.

The vehicle 10 includes external battery equipment 14 that is disposed outside of the accommodating cases 40, 50 and is electrically connected to the battery pack 13.

The external battery equipment 14 has a function of converting alternating current power supplied from an external source into direct current power that can be used by the battery 20 of the vehicle 10. This function is exhibited when the battery pack 13 is charged at a voltage and a current that are appropriate, using a household power source. The external battery equipment 14 also has a function as a direct current (DC)-to-DC converter. The external battery equipment 14 is disposed upward from the equipment case 50 so as to overlap with a portion of the equipment case 50, in its entirety, in top view.

Features of each component will be described in more detail below.

The battery case 40 includes a battery case lower member 41 and a battery case upper member 42.

The battery case upper member 42 has an upper wall portion 44. The upper wall portion 44 covers the battery 20 from upward thereof. The upper wall portion 44 functions as a floor panel that makes up a portion of a floor of the vehicle cabin. The upper wall portion 44 has an upper wall opening portion 44H that passes through this upper wall portion 44.

The equipment case 50 includes an equipment case lower member 51 and an equipment case upper member 52. The equipment case lower member 51 includes a lower wall portion 53 and a side wall portion 54.

The lower wall portion 53 has a lower wall opening portion 53H that is a hole that passes through this lower wall portion 53. Electrical connection is established between equipment such as the battery 20 and so forth in the battery case 40 and equipment such as the internal battery equipment 30 and so forth in the equipment case 50, via the upper wall opening portion 44H of the battery case upper member 42 and the lower wall opening portion 53H of the equipment case lower member 51. The lower wall portion 53 holds the internal battery equipment 30 via a plurality of bosses (omitted from illustration) and fastening members (omitted from illustration) that are provided on this lower wall portion 53.

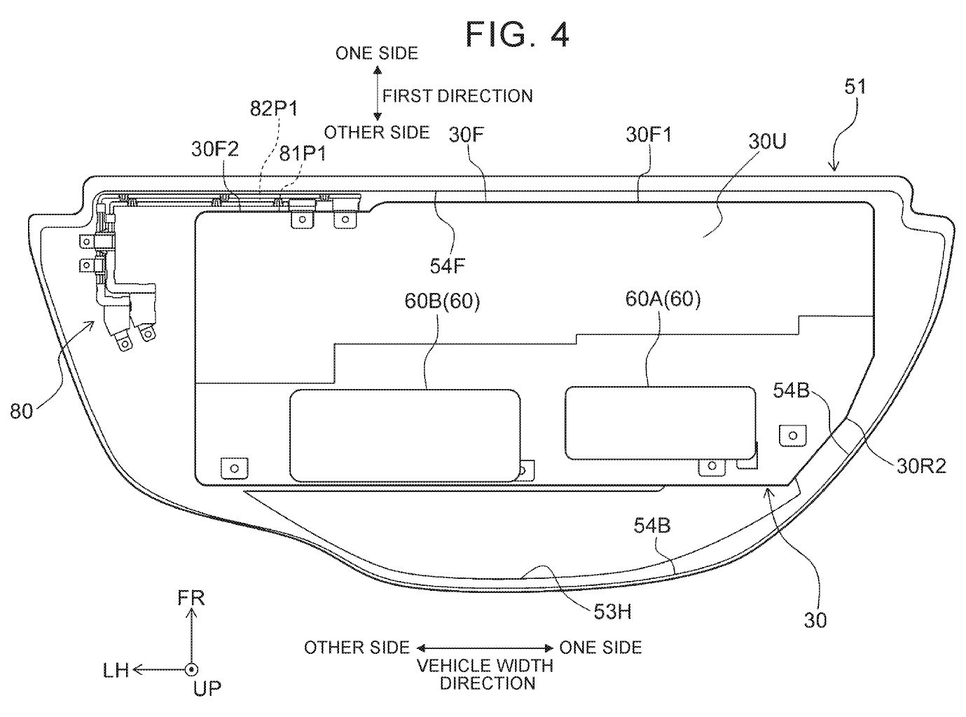

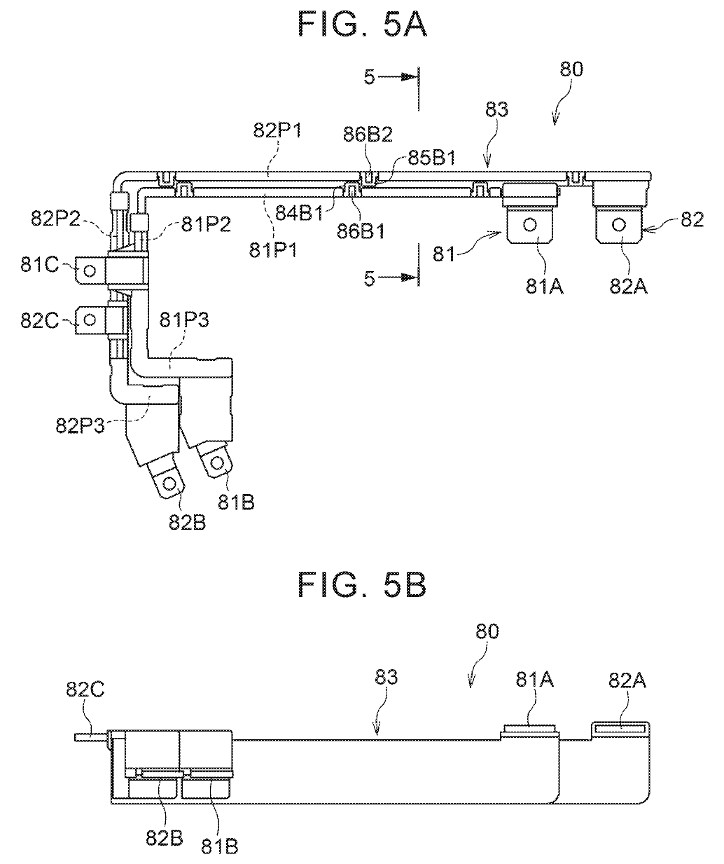

The side wall portion 54 has a front wall portion 54F. As illustrated in FIG. 4, the front wall portion 54F extends linearly in parallel with the vehicle width direction. The front wall portion 54F extends upward in a direction slightly inclined to the forward side. The side wall portion 54 has a rear wall portion 54B. The rear wall portion 54B extends in a substantially arcuate shape that is convex to the rearward side in top view.

The internal battery equipment 30 includes a plurality of (four) battery connection portions 32A, 32B, 32C, 32D to which a plurality of upper and lower connection bus bars 70, which will be described later, is connected, respectively. The battery connection portions 32A, 32B, 32C, 32D are provided at a rear of the internal battery equipment 30, when the internal battery equipment 30 is comprehended as being divided into a front portion of the internal battery equipment 30 and the rear of the internal battery equipment 30.

The internal battery equipment 30 includes a charging positive connection portion 33A that is connected to a charging positive bus bar main body 81 described later, and a charging negative connection portion 33B that is connected to a charging negative bus bar main body 82 described later. The charging positive connection portion 33A and the charging negative connection portion 33B are provided at a position in the front of the internal battery equipment 30, closer to another side in the vehicle width direction.

The internal battery equipment 30 has a front face 30F, a rear face 30B, one side face 30R in the vehicle width direction, and the other side face 30L in the vehicle width direction.

The front face 30F has a first front face 30F1 and a second front face 30F2 situated rearward of the first front face 30F1. The second front face 30F2 is provided at a position on the other side in the width direction of the front face 30F. The first front face 30F1 extends parallel to the vehicle width direction. The second front face 30F2 extends parallel to the vehicle width direction.

The front face 30F faces a front wall portion 54F of the equipment case 50 in the front-rear direction. Specifically, the first front face 30F1 and the second front face 30F2 face the front wall portion 54F of the equipment case 50 in the front-rear direction. A distance between the second front face 30F2 and the front wall portion 54F is greater than a distance between the first front face 30F1 and the front wall portion 54F. In other words, a distance in the front-rear direction between the front wall portion 54F of the equipment case 50 and the front face 30F of the internal battery equipment 30 is enlarged forward of the second front face 30F2. A part of a charging bus bar 80, which will be described later, is disposed in this portion.

The rear face 30B of the internal battery equipment 30 extends parallel to the vehicle width direction. An end on the one side of the rear face 30B of the internal battery equipment 30 in the vehicle width direction is situated closer to the other side in the vehicle width direction than an end on the one side of the front face 30F of the internal battery equipment 30 in the vehicle width direction. The other end of the rear face 30B of the internal battery equipment 30 in the vehicle width direction is situated at the same position in the vehicle width direction as the other end of the front face 30F of the internal battery equipment 30 in the vehicle width direction.

One side face 30R of the internal battery equipment 30 in the vehicle width direction includes a forward portion 30R1 and a rearward portion 30R2. The forward portion 30R1 of one side face 30R in the vehicle width direction extends parallel to a front-rear direction, and the rearward portion 30R2 of one side face 30R in the vehicle width direction extends in a direction inclined rearward toward the other side in the vehicle width direction.

The internal battery equipment 30 is disposed in a region in the equipment case 50 that is closer to one side in the vehicle width direction. Accordingly, of space within the equipment case 50, space that overlaps with the internal battery equipment 30 in a side view and is on the other side of the vehicle width direction of the internal battery equipment 30 is wider than space that overlaps with the internal battery equipment 30 in side view and is on the one side of the internal battery equipment 30 in the vehicle width direction. Wires for charging, such as a charging bus bar 80 and so forth, are disposed in this larger space.

An upper face 30U of the internal battery equipment 30 includes a first upper face 30U1 and a second upper face 30U2. The first upper face 30U1 is an upper face of a front part of the internal battery equipment 30, and the second upper face 30U2 is an upper face of a rear part of the internal battery equipment 30. The second upper face 30U2 is situated downward from the first upper face 30U1.

The external battery equipment 14 is disposed directly above the equipment case 50. The external battery equipment 14 is electrically connected to the battery pack 13 via a harness or the like that is omitted from illustration. This electrical connection is made via a charging opening portion (omitted from illustration) that passes through the equipment case upper member 52 in an up-down direction.

The battery pack 13 includes the upper and lower connection bus bars 70 that electrically connect the battery 20 and the internal battery equipment 30. The number of the upper and lower connecting bus bars 70 provided, is the same as the number of the battery modules 21 included in the battery 20. The upper and lower connecting bus bars 70 include a downward bus bar 71 attached to the battery 20 and an upward bus bar 72 attached to the internal battery equipment 30. The downward bus bar 71 includes a battery-side connection portion 73 that is connected to the battery 20, and a downward connector portion 74 that is connected to the upward bus bar 72. The upward bus bar 72 includes an equipment-side connection portion 75 that is connected to the internal battery equipment 30, and an upward connector portion 76 that is connected to the downward connector portion.

### Charging Bus Bar 80

The battery pack 13 includes the charging bus bar 80 that makes up a portion of the wiring connecting a charging port 19 provided on the outside of the battery pack 13 to the internal battery equipment 30.

The charging bus bar 80 is disposed on the other side of the internal battery equipment 30 in the vehicle width direction.

The charging bus bar 80 includes the charging positive bus bar main body 81 made of a conductive material, the charging negative bus bar main body 82 made of a conductive material, and a charging bus bar cover 83 made of an insulating material. The conductive material here is, for example, copper or aluminum.

The charging positive bus bar main body 81 has an equipment side positive connection portion 81A that is connected to the charging positive connection portion 33A of the internal battery equipment 30.

The charging negative bus bar main body 82 has an equipment side negative connection portion 82A that is connected to the charging negative connection portion 33B of the internal battery equipment 30.

The equipment-side positive connection portion 81A and the equipment-side negative connection portion 82A overlap the charging positive connection portion 33A and the charging negative connection portion 33B of the internal battery equipment 30 in top view. The thickness direction of each of the equipment-side positive connection portion 81A and the equipment-side negative connection portion 82A is oriented in the up-down direction. The equipment-side positive connection portion 81A and the equipment-side negative connection portion 82A are situated at the same positions in the up-down direction and the front-rear direction, and are situated at different positions only in the vehicle width direction.

The charging positive bus bar main body 81 has a port-side positive connection portion 81B that is connected to the charging port 19 via a wire harness or the like.

The charging negative bus bar main body 82 has a port-side negative connection portion 82B that is connected to the charging port 19 via a wire harness or the like.

The port-side positive connection portion 81B and the port-side negative connection portion 82B are situated on the outer side of the internal battery equipment 30 in the vehicle width direction. The thickness direction of each of the port-side positive connection portion 81B and the port-side negative connection portion 82B is oriented in the up-down direction. The port-side positive connection portion 81B and the port-side negative connection portion 82B are located at the same position in the up-down direction, but at different positions in the front-rear direction and in the vehicle width direction. In other words, the port-side positive connection portion 81B and the port-side negative connection portion 82B are aligned in a direction slightly inclined with respect to the vehicle width direction. The port-side positive connection portion 81B and the port-side negative connection portion 82B are situated downward from the equipment-side positive connection portion 81A and the equipment-side negative connection portion 82A.

The charging positive bus bar main body 81 has an external-equipment-side positive connection portion 81C that is connected to the external battery equipment 14 via a wire harness or the like. The charging negative bus bar main body 82 has an external-equipment-side negative connection portion 82C that is connected to the external battery equipment 14 via a wire harness or the like.

The external-equipment-side positive connection portion 81C and the external-equipment-side negative connection portion 82C are situated on the outer side of the internal battery equipment 30 in the vehicle width direction. The thickness direction of each of the external-equipment-side positive connection portion 81C and the external-equipment-side negative connection portion 82C is oriented in the up-down direction. The external-equipment-side positive connection portion 81C and the external-equipment-side negative connection portion 82C are situated at the same position in the up-down direction and the vehicle width direction, and are situated at different positions only in the front-rear direction. The external-equipment-side positive connection portion 81C and the external-equipment-side negative connection portion 82C are situated upward from the port side positive connection portion 81B and the port side negative connection portion 82B. The external-equipment-side positive connection portion 81C and the external-equipment-side negative connection portion 82C are situated on the outer side in the vehicle width direction from the port side positive connection portion 81B and the port side negative connection portion 82B.

The charging positive bus bar main body 81 has positive side parallel extending portions 81P1, 81P2, 81P3 that are strip-shaped.

The charging negative bus bar main body 82 has negative-side parallel extending portions 82P1, 82P2, 82P3 that are strip-shaped.

The positive-side parallel extending portions 81P1, 81P2, 81P3 and the negative-side parallel extending portions 82P1, 82P2, 82P3 have thickness directions thereof oriented in the same direction and also extend parallel to each other with a gap therebetween in the plate thickness direction. The thickness directions of the positive-side parallel extending portions 81P1, 81P2, 81P3 and the negative-side parallel extending portions 82P1, 82P2, 82P3 are oriented in a direction perpendicular to the up-down direction.

The positive-side parallel extending portions 81P1, 81P2, 81P3 include a first positive-side parallel extending portion 81P1, a second positive-side parallel extending portion 81P2, and a third positive-side parallel extending portion 81P3.

The negative-side parallel extending portions 82P1, 82P2, 82P3 include a first negative-side parallel extending portion 82P1, a second negative-side parallel extending portion 82P2, and a third negative-side parallel extending portion 82P3.

The first positive-side parallel extending portion 81P1 and the first negative-side parallel extending portion 82P1 have the plate thickness directions thereof oriented in the same direction (front-rear direction) and also extend parallel to each other with a gap therebetween in the plate thickness direction. The extending direction thereof is the vehicle width direction.

The second positive-side parallel extending portion 81P2 and the second negative-side parallel extending portion 82P2 have the plate thickness directions thereof oriented in the same direction (vehicle width direction) and also extend parallel to each other with a gap therebetween in the plate thickness direction. The extending direction is the front-rear direction.

The third positive-side parallel extending portion 81P3 and the third negative-side parallel extending portion 82P3 have the plate thickness directions thereof oriented in the same direction (front-rear direction) and also extend parallel to each other with a gap therebetween in the plate thickness direction. The extending direction thereof is the vehicle width direction.

The charging bus bar cover 83 covers at least the positive-side parallel extending portions 81P1, 81P2, 81P3 and the negative-side parallel extending portions 82P1, 82P2, 82P3 of the charging positive bus bar main body 81 and the charging negative bus bar main body 82.

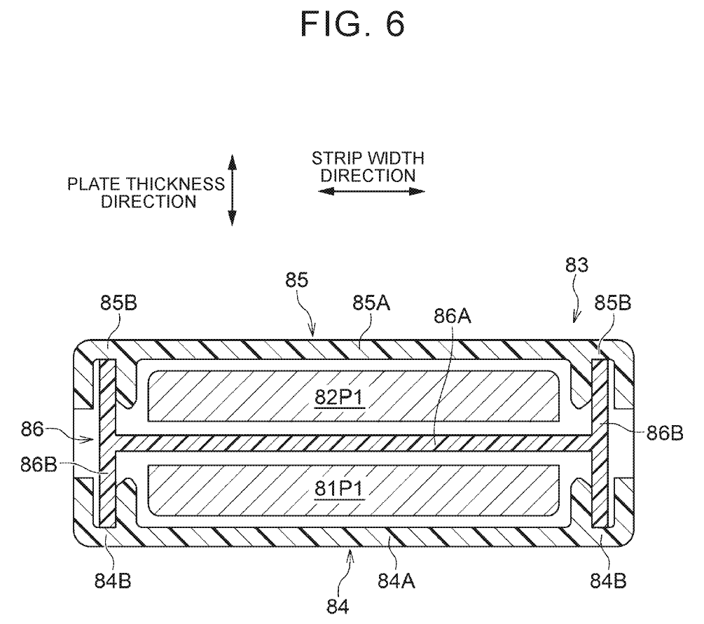

As illustrated in FIG. 6, the charging bus bar cover 83 includes a positive-side cover 84, a negative-side cover 85, and an intermediate cover 86. The positive-side cover 84, the negative-side cover 85, and the intermediate cover 86 are formed as separate bodies from each other.

The positive-side cover 84 has a positive-side wall portion 84A that covers the first positive-side parallel extending portion 81P1. The negative-side cover 85 has a negative-side wall portion 85A that covers the first negative-side parallel extending portion 82P1. The intermediate cover 86 has a partition wall portion 86A disposed between the first positive-side parallel extending portion 81P1 and the first negative-side parallel extending portion 82P1.

The intermediate cover 86 has a pair of upright wall portions 86B extending in the plate thickness direction. The positive-side cover 84 has a pair of holding portions 84B that clamps and holds the upright wall portions 86B in a strip width direction. The negative-side cover 85 has a pair of holding portions 85B that clamps and holds the upright wall portions 86B in the strip width direction.

The upright wall portions 86B have a positive-side protrusion 86B1 that projects outward in the strip width direction, and a negative-side protrusion 86B2 that projects outward in the strip width direction. The positive-side cover 84 has a retained portion 84B1 that is retained by the positive-side protrusion 86B1. The negative-side cover 85 has a retained portion 85B1 that is retained by the negative-side protrusion 86B2. The positive-side protrusion 86B1 and the negative-side protrusion 86B2 are provided at different positions in the extending direction.

The first positive-side parallel extending portion 81P1 and the first negative-side parallel extending portion 82P1 are provided at a position forward of (on the first direction side of) the front face 30F (first face) of the internal battery equipment 30, following this front face 30F, in a state in which the plate thickness directions thereof are oriented in the front-rear direction (first direction). Note that the first direction may be another direction that is perpendicular to the up-down direction. Hereinafter, the front face 30F may be referred to as first face 30F.

The portion of the front face 30F of the internal battery equipment 30 along which the first positive-side parallel extending portion 81P1 and the first negative-side parallel extending portion 82P1 are provided following has a recessed portion (second front face 30F2) recessed in the inward side in the first direction relative to other general portions (first front face 30F1) of this front face 30F. Hereinafter, the first front face 30F1 may be referred to as general portion 30F1, and the second front face 30F2 may be referred to as recessed portion 30F2.

### Functions and Effects

Next, the functions and effects of the present embodiment will be described.

The present embodiment relates to the battery pack 13 installed in the vehicle 10 as illustrated in FIG. 1. The battery pack 13 includes the battery 20, the internal battery equipment 30 electrically connected to the battery 20, the charging bus bar 80 that makes up a portion of the wiring connecting the charging port 19 provided externally from this battery pack 13 to the internal battery equipment 30, and the accommodating cases 40, 50 that accommodate the battery 20, the internal battery equipment 30, and the charging bus bar 80. The charging bus bar 80 includes the charging positive bus bar main body 81 and the charging negative bus bar main body 82.

However, noise may be generated due to the charging bus bar 80 as described above.

Accordingly, in the present embodiment, the charging positive bus bar main body 81 has the positive-side parallel extending portion 81P1 that is strip-shaped, and the charging negative bus bar main body 82 has the negative-side parallel extending portion 82P1 that is strip-shaped. The positive-side parallel extending portion 81P1 and the negative-side parallel extending portion 82P1 have plate thickness directions thereof oriented in the same direction and also extend in parallel with a gap therebetween in the plate thickness direction.

Accordingly, magnetic fields generated around the charging bus bar 80 can be canceled out, and as a result, noise caused by the magnetic fields can be reduced.

In the present embodiment, the battery pack 13 also includes the charging bus bar cover 83. As illustrated in FIG. 6, the charging bus bar cover 83 includes the positive-side cover 84, the negative-side cover 85, and the intermediate cover 86. The positive-side cover 84, the negative-side cover 85, and the intermediate cover 86 are formed as separate bodies from each other. The positive-side cover 84 has the positive-side wall portion 84A that covers the positive-side parallel extending portion 81P1, the negative-side cover 85 has the negative-side wall portion 85A that covers the negative-side parallel extending portion 82P1, and the intermediate cover 86 has the partition wall portion 86A that is disposed between the positive-side parallel extending portion 81P1 and the negative-side parallel extending portion 82P1.

Accordingly, in comparison with a form in which a cover is provided to surround the positive side parallel extending portion 81P1 on all sides and a cover is provided to surround the negative side parallel extending portion 82P1 on all sides, reduction in the number of parts is easier, and also narrowing a gap between the positive side parallel extending portion 81P1 and the negative side parallel extending portion 82P1 is easier. The reason thereof is that, in a form in which a cover is provided to surround the positive side parallel extending portion 81P1 on all sides and a cover is provided to surround the negative side parallel extending portion 82P1 on all sides, there will be two wall portions disposed between the positive side parallel extending portion 81P1 and the negative side parallel extending portion 82P1.

Also, in the present embodiment, the intermediate cover 86 has the upright wall portions 86B extending in the plate thickness direction. The positive-side cover 84 has the holding portions 84B that clamp and hold the upright wall portions 86B in the strip width direction, and the negative-side cover 85 has the holding portions 85B that clamp and hold the upright wall portions 86B in the strip width direction.

Also, in the present embodiment, the upright wall portions 86B have the positive-side protrusion 86B1 that projects outward in the strip width direction, and the negative-side protrusion 86B2 that projects outward in the strip width direction. The positive-side cover 84 has the retained portion 84B1 that is retained by the positive-side protrusion 86B1, and the negative-side cover 85 has the retained portion 85B1 that is retained by the negative-side protrusion 86B2.

Accordingly, the positive-side cover 84, the negative-side cover 85, and the intermediate cover 86 can be integrated with a simple structure.

Also, in the present embodiment, the internal battery equipment 30 has the first face 30F facing the first direction. The positive-side parallel extending portion 81P1 and the negative-side parallel extending portion 82P1 are provided such that the positions on the first direction side of the first face follow along this first face in a state in which the plate thickness direction facing the first direction.

Accordingly, the internal battery equipment 30 and the charging bus bar 80 can be efficiently disposed inside the accommodating cases 40 and 50.

Also, according to the present embodiment, the portion of the first face 30F along which the positive-side parallel extending portion 81P1 and the negative-side parallel extending portion 82P1 are provided following has the recessed portion 30F2 recessed in the inward side in the first direction relative to the other general portions 30F1 of this first face 30F.

Accordingly, the internal battery equipment 30 and the charging bus bar 80 inside the accommodating cases 40 and 50 can be more efficiently disposed.

Although a preferred embodiment of the present disclosure has been described above, the present disclosure is not limited to the description above.

What is claimed is:

1. A battery pack that is installed in a vehicle, the battery pack comprising:
a battery;
internal battery equipment that is electrically connected to the battery;
a charging bus bar that makes up a portion of wires connecting a charging port provided outside of the battery pack and the internal battery equipment; and
an accommodating case that accommodates the battery, the internal battery equipment, and the charging bus bar, wherein
the charging bus bar includes a charging positive bus bar main body and a charging negative bus bar main body,
the charging positive bus bar main body includes a positive-side parallel extending portion that is strip-shaped,
the charging negative bus bar main body includes a negative-side parallel extending portion that is strip-shaped, and
a plate thickness direction of the positive-side parallel extending portion and a plate thickness direction of the negative-side parallel extending portion are oriented in the same direction, and also extend parallel to each other with a gap between in the plate thickness direction.

2. The battery pack according to claim 1, further comprising:
a charging bus bar cover, wherein
the charging bus bar cover includes
a positive-side cover,
a negative-side cover, and
an intermediate cover,
the positive-side cover, the negative-side cover, and the intermediate cover are fashioned as separate bodies from each other,
the positive-side cover includes a positive-side wall portion that covers the positive-side parallel extending portion,
the negative-side cover includes a negative-side wall portion that covers the negative-side parallel extending portion, and
the intermediate cover includes a partition wall portion that is disposed between the positive-side parallel extending portion and the negative-side parallel extending portion.

3. The battery pack according to claim 2, wherein
the intermediate cover includes a pair of upright wall portions extending in the plate thickness direction,
the positive-side cover includes a pair of holding portions that clamps and holds the upright wall portions in a strip width direction,
the negative-side cover includes a pair of holding portions that clamps and holds the upright wall portions in the strip width direction,
the upright wall portions include
a positive-side protrusion that projects outward in the strip width direction, and
a negative-side protrusion that projects outward in the strip width direction,
the positive-side cover includes a retained portion that is retained by the positive-side protrusion, and
the negative-side cover includes a retained portion that is retained by the negative-side protrusion.

4. The battery pack according to claim 1, wherein
the internal battery equipment includes a first face that faces in a first direction, and
the positive-side parallel extending portion and the negative-side parallel extending portion are provided such that positions on the first direction side of the first face follow along the first face, in a state in which the plate thickness directions face the first direction.

5. The battery pack according to claim 4, wherein a portion of the first face along which the positive-side parallel extending portion and the negative-side parallel extending portion are provided following is a recessed portion that is recessed inward in the first direction relative to another general portion of the first face.
